(19) United States
(12) Patent Application Publication
(10) Pub. No.: US 2019/0374053 A1
(43) Pub. Date: Dec. 12, 2019

(54) JUG

(71) Applicant: ILSA S.r.l., Collegno (Torino) (IT)

(72) Inventor: Rosso ROBERTO, Collegno (Torino) (IT)

(73) Assignee: ILSA S.r.l., Collegno (Torino) (IT)

(21) Appl. No.: 16/431,137

(22) Filed: Jun. 4, 2019

(30) Foreign Application Priority Data
Jun. 7, 2018 (IT) 202018000002693

(51) Int. Cl. A47G 19/12

(52) U.S. Cl. CPC A47G 19/12; A47J 31/4496

(57) ABSTRACT

A jug comprising a container body, and a spout wherein said container body has a main axis (x) about which said container body develops, said spout being positioned in a given angular position about said main axis (x), and said spout defines an outflow section for pouring the liquid that is to be contained in said container body and a further spout which, with respect to said first spout is provided in a different angular position about said main axis (x) and defines a smaller outflow section.

The present invention relates to a jug, in particular a jug for the preparation of milk.

As is known, a milk jug can be used for preparing cappuccino or coffee with a dash of milk, i.e., for heating and frothing the milk via injection of a jet of steam into the jug to obtain a cream or froth on the surface, which is then poured together with the milk into the mug or cup so as to come to form the uppermost layer of the beverage.

In the professional field, for example in coffee bars, on the layer of froth decorations are very often provided by “sprinkling” coffee on the froth so as to exploit the contrast of colour for making ornamental patterns of any type.

In this context, the jug described herein is able, thanks to its characteristics that will be described in what follows, to facilitate the preparation referred to above, moreover providing the user with the possibility of making more precise and/or elaborate decorations.

In particular, the jug described herein is characterized by the features recalled in claim 1.

The characteristics referred to in the claims form an integral part of the technical teaching provided herein.

Further characteristics and advantages of the present invention will emerge clearly from the ensuing description with reference to the annexed drawings, which are provided purely by way of non-limiting example and in which:

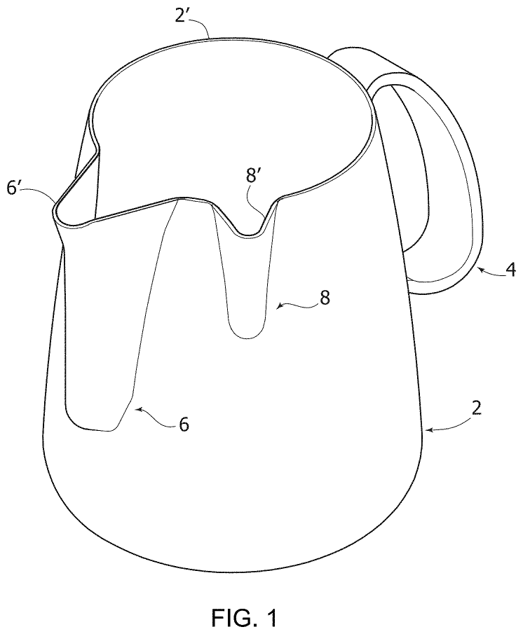

FIG. 1 illustrates an axonometric view of an embodiment of the jug described herein;

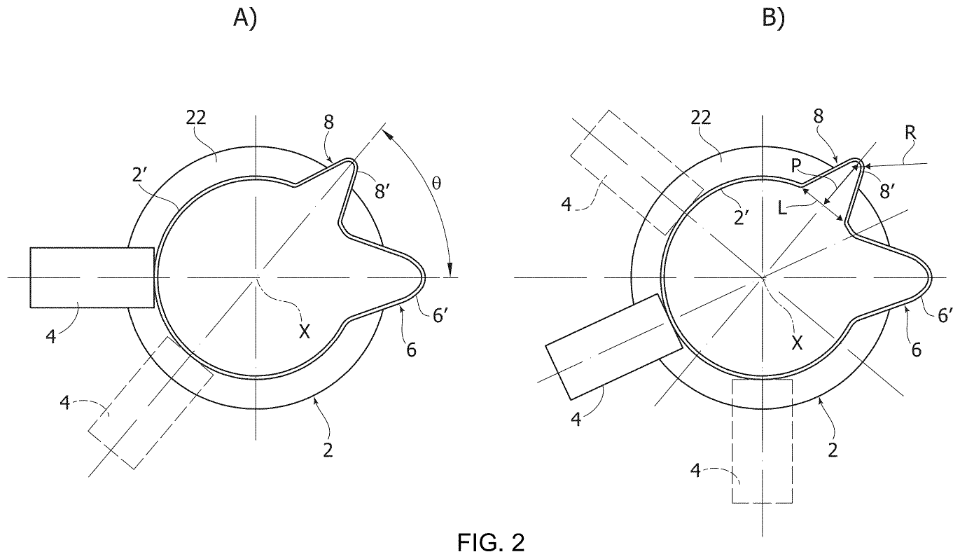

FIG. 2 illustrates a top plan view of the jug of FIG. 1; and

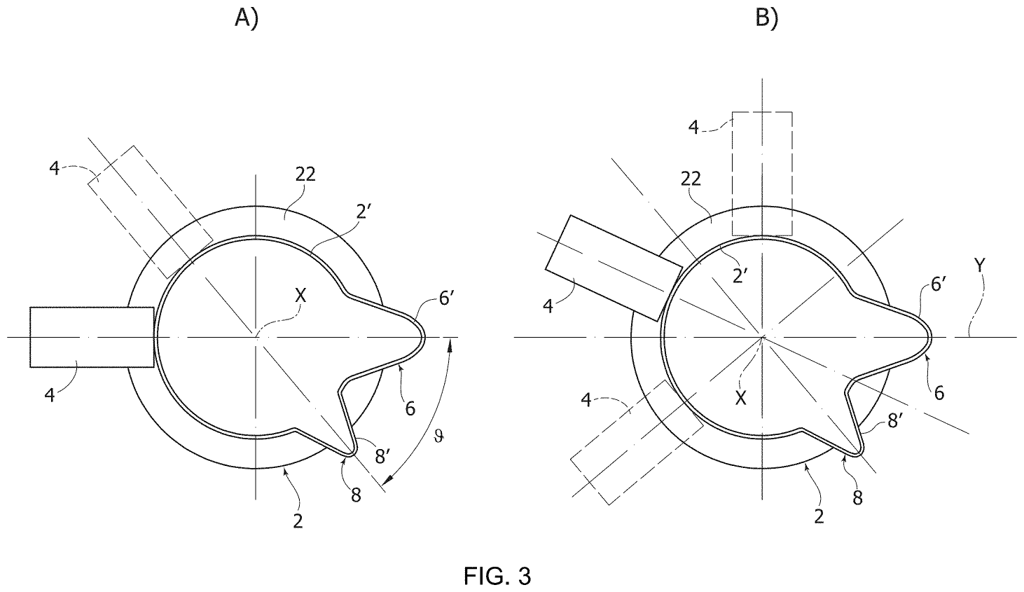

FIGS. 3 to 6 are top plan views of further embodiments of the jug described herein.

In the ensuing description, various specific details are illustrated aimed providing at an in-depth understanding of the embodiments. The embodiments may be obtained without one or more of the specific details, or with other methods, components, or materials, etc. In other cases, known structures, materials, or operations are not shown or described in detail so that various aspects of the embodiment will not be obscured.

The references used herein are provided only for convenience and hence do not define the sphere of protection or the scope of the embodiments.

With reference to the drawings, the jug described herein comprises, in a way in itself known, a container body 2 and, possibly, a handle 4. In some embodiments, the handle 4 may be replaced with a band of insulating material wrapped around the body 2.

The jug described herein is characterized in that it has a first spout 6 and a second spout 8, which are provided in different positions about the main axis X of the body 2 that define respective outflow sections of different dimensions. With reference to the example illustrated in FIGS. 1 and 2, the spout 8 defines an outflow section smaller than that of the spout 6, as will be seen in the ensuing detail.

In general, the two spouts of the jug described herein are purposely configured for performing two different operations during preparation of a cappuccino or of a coffee with a dash of milk; i.e., the larger spout is used for pouring the hot milk and a first part of froth, whereas the smaller spout is used for making the decorations with a second part of froth.

The angular distance between the two spouts, about the main axis X of the container body 2, must be such as to enable pouring of the liquid selectively through just one of the two spouts by tilting the container body 2 accordingly, without the liquid coming out also through the other spout.

In various preferred embodiments, as in the one illustrated, the two spouts 6 and 8 are positioned with respect to one another at an angular distance equal to or greater than 30°. In the figures, this angular distance is designated by the reference θ.

On the other hand, the relative angular position of the two spouts can be selected according to the preferences of the users as will be said hereinafter.

With reference now to the drawings, the container body 2 is preferably made of metal material, such as aluminium, stainless steel, etc., and is obtained starting from metal plate, which is appropriately cut and subjected to an operation of drawing to obtain the desired shape.

In particular, the side wall of the container body 2, designated by the reference number 22, is shaped so as to define an internal volume that, for at least one part thereof, has a variable cross section along the main axis X of the body according to a development decreasing in the direction of the mouth rim 2′ of the container.

Said conformation of the wall 22 has a dual function. On the one hand, it favours heating of the liquid contained in the jug. On the other hand, with particular reference to the operation of frothing of the milk, it triggers, as a result of the jet of steam envisaged during this operation, a swirling motion of the milk that is designed to favour the process of transformation of the milk into cream or froth.

In various preferred embodiments, as in the one illustrated, the two spouts 6 and 8 are provided at the mouth rim 2′ of the container body 2. In particular, the two spouts 6 and 8 are constituted by concave walls that project radially from the profile of the mouth rim 2′ and extend along the central axis X for a limited stretch.

At least for the larger spout 6, the extension along the axis X may in any case reach and in some cases exceed one third of the overall height of the body 2.

In plan view (see FIG. 2) said walls define a V-shaped profile with rounded bottom, which faces the centre of the container body 2.

In various preferred embodiments, as in the one illustrated, the walls in question are shaped in such a way that the dimensions of the aforesaid profile—depth (in the radial direction) and width—increase in the direction from the bottom of the jug to the mouth rim 2′. On the top, the above walls each define an edge—designated by the reference number 6′ for the spout 6, and by the reference number 8′ for the spout 8—that seamlessly joins to the mouth rim 2′ at the opposite side ends of the respective spout. This edge identifies the outflow section of the spout.

As mentioned above, the outflow section of the spout 8 is smaller than that of the spout 6. Preferably, the spout 6 has the same dimensions as the spout of a conventional jug. With reference to FIG. 2, with respect to the edge 6′ of said spout, the edge 8′ of the spout 8 defines a V-shaped profile having a maximum width L, depth P, and a radius of curvature R of the bottom of the profile that are smaller. In various preferred embodiments, as in the one illustrated, the outflow section of the spout 8 is equal to or less than 80% of the outflow section of the spout 6, even more preferably equal to or less than 60%.

As mentioned above, the spout 8 is purposely provided for making the final decoration of the cream or froth. In fact, since it is in general smaller and presents the shape referred to above, it facilitates the user in controlling the flow of milk that is poured, and hence allows him to be more precise and accurate in the defining of the envisaged ornamental patterns.

It should be noted that, to pass from use of the spout 6 to use of the spout 8, the user must basically perform a movement of the wrist without any need to vary his grip of the jug. This movement clearly depends upon the relative position between the two spouts 6 and 8.

Advantageously, it is possible to envisage models of jug that differ from one another as regards the relative position of the two spouts 6 and 8, and possibly also as regards the relative position between the handle 4 and the aforesaid spouts in order to satisfy the various preferences of the users.

In this connection, in the embodiment of FIG. 2 the spouts 6 and 8 are positioned with respect to one another at an angular distance apart of approximately 50°. Moreover illustrated in FIG. 2 are five possible positions of the handle 4 (of which some are represented with a dashed line); for a greater clarity of representation, the image of the jug has been reproduced twice in the representations a) and b). With reference to this figure, it emerges clearly how the position itself of the handle 4 affects the type of movement that the user must make to pass from use of the spout 6 to use of the spout 8.

FIG. 3 shows a version of the jug in which the various elements are positioned in an exactly specular way to that of FIG. 2, with respect to the reference line Y indicated in the figure.

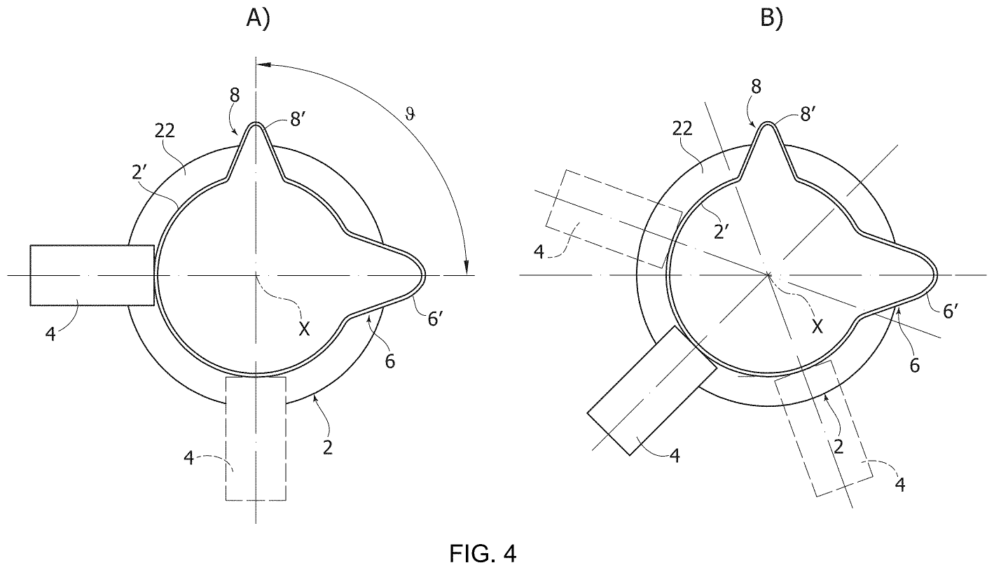

FIG. 4 illustrates, instead, a model of the jug in which the two spouts 6 and 8 are at an angular distance apart of 90°. Also in this figure different possible positions of the handle 4 with respect to the two spouts 6 and 8 are represented.

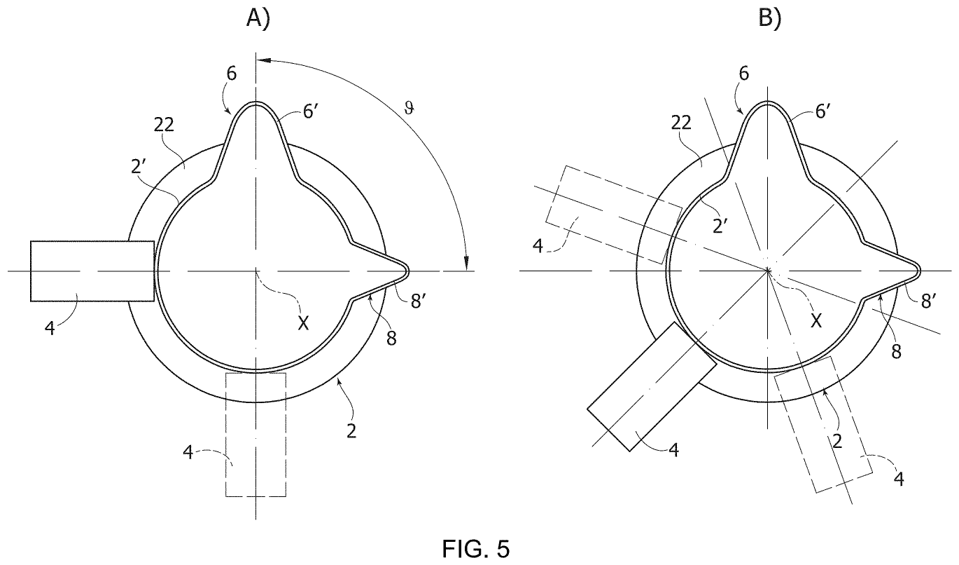

The model of jug illustrated in FIG. 5 differs from that of FIG. 4 simply in the reversed positioning of the two spouts 6 and 8.

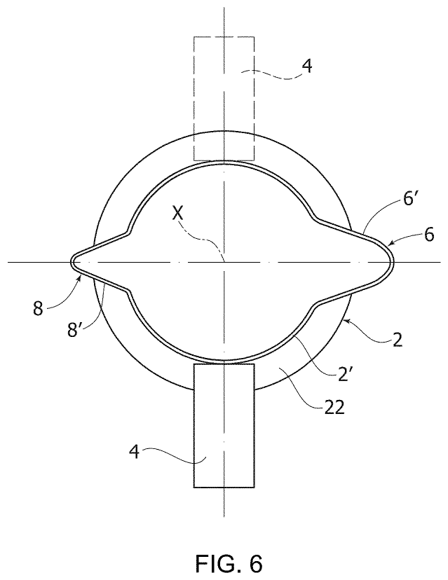

Finally, FIG. 6 illustrates a model of jug in which the two spouts 6 and 8 are at an angular distance apart of 180°; represented in this figure are two possible alternative positions of the handle 4.

The two spouts 6 and 8 can be provided directly starting from the container body 2, through an operation of shaping subsequent to the operation of drawing referred to above, or else via addition of parts, appropriately shaped, which are welded to the container body 2, after this has been appropriately prepared.

The handle 4 is also preferably made of metal material; for example, it can be obtained starting from a piece of metal plate that is first appropriately cut and then bent into the desired shape. The handle 4 can be connected to the body 2 via welding or else through the use of fixing members, for example screws.

Of course, without prejudice to the principle of the invention, the details of construction and the embodiments may vary, even significantly, with respect to what has been illustrated herein purely by way of non-limiting example, without thereby departing from the scope of the invention, as defined by the annexed claims.

1. A jug comprising:
a container body, and a first spout attached to said container body, wherein:
said container body has a main axis (X) about which said container body is disposed,
said first spout is positioned in a given angular position about said main axis (X), and
said first spout defines an outflow section for pouring the liquid that is to be contained in said container body,
said jug further comprises a second spout that, with respect to said first spout, is provided in a different angular position about said main axis (X) and defines a smaller outflow section.

2. The jug according to claim 1, wherein said first and second spouts are positioned with respect to one another at an angular distance equal to or greater than 30°, about said main axis (X).

3. The jug according to claim 1, wherein said first and second spouts are positioned with respect to one another according to at least one of:
at an angular distance of approximately 90° about said main axis (X); and
at an angular distance of between 40° and 70° about said main axis (X); and
at an angular distance of approximately 180° about said main axis (X).

4. The jug according to claim 1, wherein the outflow section of said second spout is smaller than or equal to 80% of the outflow section of said first spout, preferably smaller than or equal to 60%.

5. The jug according to claim 1, wherein said first and second spouts each have a V-shaped profile with rounded bottom, and wherein, with respect to said first spout, said second spout defines a V-shaped profile having a width (L), depth (P), and radius of curvature (R) of the bottom of the profile that are smaller.

6. The jug according to claim 1, wherein said first and second spouts are provided on the mouth rim of said container body and each have a respective top edge that constitutes a continuation of said mouth rim deviating with respect to the ideal profile followed by said mouth rim.

7. The jug according to claim 1, comprising a handle fixed to said container body, and
a band made of insulating material wrapped around said container body.
